(19) United States
(12) Patent Application Publication
(10) Pub. No.: US 2004/0027822 A1
(43) Pub. Date: Feb. 12, 2004

(54) Brightness-adjustable illumination device

(76) Inventor: Rainer Biro, Hechingen (DE)

Correspondence Address: Friedrich Kueffner, Suite 910, 317 Madison Avenue, New York, NY, 10017, US

(21) Appl. No.: 10/601,323

(22) Filed: Jun. 20, 2003

(30) Foreign Application Priority Data
Jun. 25, 2002 (DE) 102 28 317.6

(51) Int. Cl. F21L 4/04; F21V 23/00

(52) U.S. Cl. 362/109; 362/205; 362/295

(57) ABSTRACT

A brightness-adjustable illumination device for manual use has a main body and an electric light source arranged in the main body. A manually actuatable operating element is arranged on the main body and controls the brightness of the light source. The operating element is adjusted by a linear sliding movement. wherein the operating element comprises an adjustable electric resistor for controlling an electric current intensity flowing through the light source. The adjustable electric resistor is a sliding potentiometer provided with a sliding contact secured on the main body. The sliding potentiometer has a winding movable relative to the sliding contact.

### BACKGROUND OF THE INVENTION

1. Field of the Invention

The invention relates to a brightness-adjustable illumination device to be used by hand, in particular, for use in medical diagnostics and/or therapy, comprising a main body with an electric light source and a manually actuatable operating element for controlling brightness of the light source. In this context, brightness control is to be understood as a control which is able to control the light source—optionally, in addition to an on/off function—for illumination at different brightness levels.

2. Description of the Related Art

Illumination devices of this kind are used by physicians and other service providers of the medical sector for a targeted illumination of parts of the human body for diagnosis and therapy of patients. The illumination device, conventionally having an elongate shape, is usually held in one hand by the medical personnel. An illumination head is usually provided at one end of the illumination device from which a directed light beam is emitted. Usually, beneath the illumination head a sleeve is provided which is rotatable about the longitudinal axis of the illumination device and by which a rotary potentiometer can be actuated. In other embodiments, the entire front section of the illumination device is rotated for actuating the rotary potentiometer. As a result of the rotation, the resistance value of the rotary potentiometer can be continuously adjusted so that a position can be selected in which no current flows at all. In this way, the electric current intensity flowing through the light source can be varied and, in this way, the brightness of the illumination device can be controlled continuously. However, the known brightness-adjustable illumination devices have problems. The brightness control by rotation of the sleeve or of the front section of the illumination device requires usually the use of the other hand. While the device is held with one hand, the rotary element is manipulated by the other hand. In some cases, the rotary element can be adjusted by the index finger and thumb of the same hand that holds the device. However, this is cumbersome and extremely unfavorable with respect to ergonomic considerations because, firstly, two fingers must be used for rotating the rotary element and, secondly, the hand must be rotated in an unnatural way to a certain degree.

### SUMMARY OF THE INVENTION

It is an object of the present invention to provide a brightness-adjustable illumination device of the aforementioned kind which can be held with one hand and can be adjusted with respect to its brightness by the same hand without difficulty and in an ergonomically advantageous way.

In accordance with the present invention, this is achieved in that the operating element is adjustable by means of a linear movement, in particular, by a linear sliding action of the operating element.

By adjusting the illumination device by means of a linear movement, in particular, by a linear sliding movement, of the operating element, it is possible to carry out the adjusting action, for example, by means of the thumb or the index finger of the hand holding the illumination device. Accordingly, only a back and forth movement of a single finger is required while the remaining fingers together with the palm of the hand are available for holding the illumination device. In this way, the brightness adjustment can be carried out easily and also in an ergonomically advantageous way because the hand can remain in its natural position during this adjusting action and must not be rotated.

It was found to be advantageous in connection with the invention when the main body which is, in particular, rod-shaped has a longitudinal axis and the linear movement for adjusting the operating element, in particular, the linear sliding movement of the operating element, is carried out parallel to the longitudinal axis of the main body. In this way, a particularly ergonomic manipulation of the illumination device is achieved. The ease of operation of the illumination device, which rests particularly ergonomically in the hand because of the rod-shaped of its main body, is even more enhanced by the linear sliding action of the operating element parallel to the longitudinal axis of the main body. In this way, the operating element can be moved by a natural back and forth movement of a finger holding the illumination device.

Moreover, it can be advantageous when the illumination device is continuously brightness-adjustable. In this way, the operator can react in a flexible way to the different illumination requirements on different locations of the human body and with respect to different examination and treatment situations by selecting the optimal brightness intensity, respectively.

In an expedient embodiment of the device according to the invention, the operating element has an adjustable electric resistor, in particular, a sliding potentiometer, for controlling the electric current intensity flowing through the light source. In this way, the movement of the operating element can be converted directly into an electric resistance change in the electric circuit in which the electric light source is arranged. In this way, the electric current intensity flowing through the light source is changed accordingly so that, in turn, the brightness of the light source is controlled. By means of a sliding potentiometer, the linear movement of the operating element can be converted, without requiring any further force deflection device, into an electric resistance change so that the configuration of the illumination device is simplified and its costs are reduced.

Moreover, it can be advantageous when the sliding contact of the sliding potentiometer is secured on the main body and the winding of the sliding potentiometer is movable relative to the sliding contact. In this way, the winding can be arranged outside of the main body so that additional space in the main body for the winding is not required.

In this way, a simple configuration of the illumination device according to the invention is provided and the space requirement of the device is over all optimized. Moreover, the design of the main body known from conventional illumination device must not be redesigned for use according to the invention so that costs are saved.

In a particularly advantageous configuration, the illumination device has a mechanical resistance element by means of which, upon adjusting of the operating element between a rest position without illumination output and an operating position with illumination output, a mechanical resistance is provided which makes the adjusting action momentarily difficult. Accordingly, the operation of the illumination device according to the invention is facilitated because the operator recognizes simply by means of the mechanical resistance felt upon adjusting of the operating element that the illumination device has been switched on or switched off. Visual checking of the switching state is therefore not required.

Moreover, it was found to be expedient when the mechanical resistance is in the form of a profile change, in particular, a projection, on the main body and the operating element has a spring element which exerts a force onto the resistance element when adjusting the operating element between a rest position and an operating position. In one embodiment, a ball, which is forced by means of an elastic spring against the main body, is guided along the main body upon adjustment of the operating element. When the operating element is moved in the direction of the operating position, the ball is moved because of the projection in the direction of the elastic spring so that the spring is compressed. The force expenditure required for this spring compression provides a mechanical resistance upon movement of the operating element between the rest position and the operating position and vice versa. This configuration provides a space-saving and cost-saving realization of an adjusting mechanism with mechanical resistance.

In another advantageous configuration of the device according to the invention, the rod-shaped illumination device has an indicator device for visually indicating the adjusted brightness level of the illumination device. This indicator device makes the illumination device more user-friendly because the brightness level of the illumination device can be easily read on the indicator device. In this way, it is possible to easily reproduce a brightness level found to be optimal in a prior examination for use in a similar type of examination.

In an expedient embodiment, the indicator device represents the brightness levels uniformly in steps. This means that the brightness levels are represented in intervals on the indicator device. This can be realized, for example, by means of a sequence of dots that increase in size. The surface area of the represented dots corresponds to the adjusted brightness level. It was found to be expedient to provide four dots of increasing size arranged adjacently to one another on the indicator device. Depending on the adjusted brightness range of the illumination device, one of the dots is marked for visual recognition. As a result of the limited number of indicator values, selected in accordance with the requirements in practice, the user friendliness of the illumination device is further increased because the operator is not confused by unnecessary intermediate values. Also, the use of intuitive symbols for indicating the brightness improves the usability of the device.

Moreover, it is advantageous when the main body has a housing for receiving at least one battery for operating the electric light source. A battery in this context can be a rechargeable primary cell or a rechargeable secondary cell or an accumulator. Since in this way the energy source is integrated into the illumination device, the device can be used independently of its environment and can therefore be used in any type of environment.

Moreover, it can be advantageous when the illumination device has a fastening device, in particular, a clip, for detachably securing the illumination device on external objects. Accordingly, the illumination device can be attached or clamped to a pocket of a piece of clothing such as a physician's coat, so that in this way the device is kept from sliding out of a pocket when moving quickly or when assuming certain body postures.

In a particularly advantageous configuration, the operating element and/or the adjustable electric resistor and/or the mechanical resistance device and/or the indicator device can be arranged in the area of the fastening device, in particular, can be substantially integrated into the fastening device. For example, the above-mentioned elements can be integrated into the connecting area of the clip provided for fastening. This provides a particularly space-saving configuration because the space available in the area of the clip can be optimally used in this way.

The illumination device, for example, can be an otoscope, an ophthalmoscope, or a manual slit lamp.

### BRIEF DESCRIPTION OF THE DRAWING

In the drawing:

FIG. 1 is a longitudinal sectional view of the brightness-adjustable illumination device according to the invention for use by hand, showing the device in a position in which no illumination output is provided;

FIG. 2 is a plan view onto the operating element of the brightness-adjustable illumination device in the position of FIG. 1;

FIG. 3 is a longitudinal sectional view of the brightness-adjustable illumination device according to FIG. 1 in a position in which the device provides a minimal illumination output;

FIG. 4 is a plan view onto the operating element of the brightness-adjustable illumination device in the position of FIG. 3;

FIG. 5 is a longitudinal sectional view of the brightness-adjustable illumination device according to FIG. 1 in a position in which the device provides maximum illumination output;

FIG. 6 is a plan view onto the operating element of the brightness-adjustable illumination device in the position of FIG. 5.

### DESCRIPTION OF THE PREFERRED EMBODIMENTS

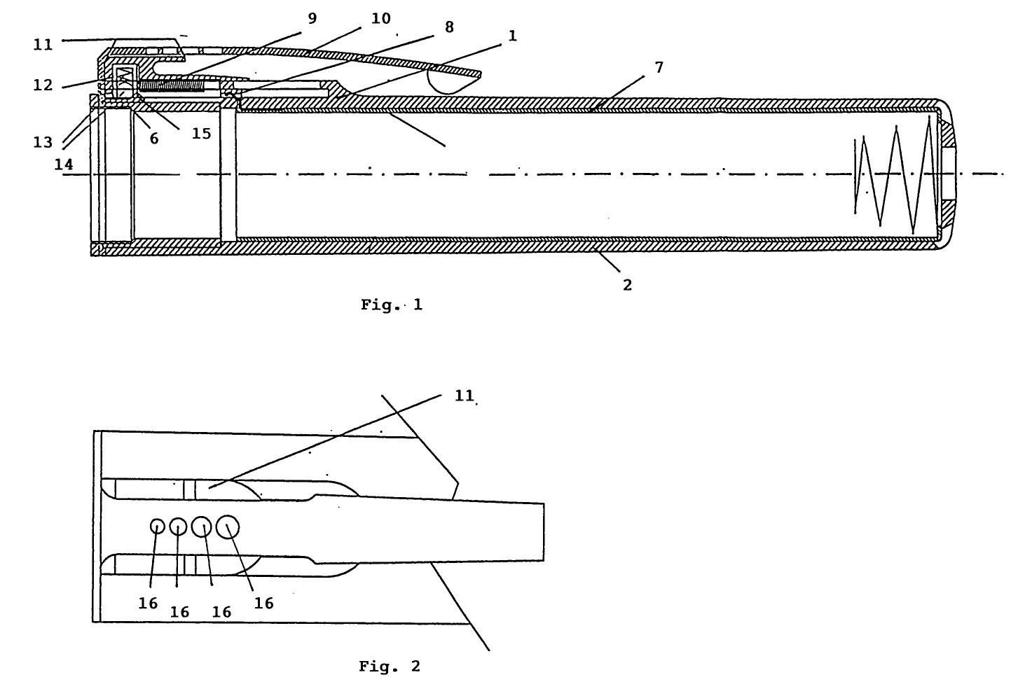

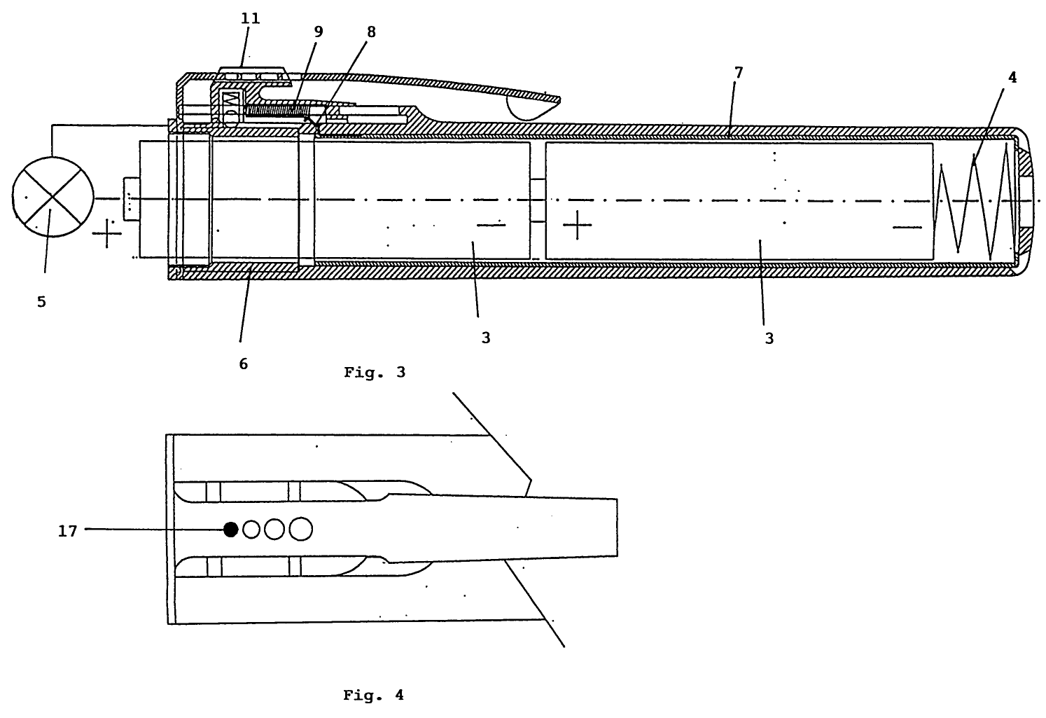

One embodiment of the brightness-adjustable illumination device according to the invention for use by hand will be explained in connection with FIG. 1. This illumination device has a substantially rod-shaped main body 1 having at its left end a clamping element (clip) 10 for detachable fastening of the illumination device, for example, on a piece of clothing. The main body 1 has a housing 2 for receiving batteries 3 (illustrated in FIG. 3). The batteries 3 are inserted from the left side into the housing 2 until they come to rest against a battery tensioning spring 4 mounted on the right end of the housing 2. Subsequently, a lamp attachment comprising an incandescent light bulb 5 is screwed into a receptacle 6 inserted into the left end of the housing 2. When doing so, the batteries 3 are moved to the right so that the battery tensioning spring 4 is compressed. The lamp attachment is now connected to the batteries 3 at the positive terminal while the negative terminal is contacted by the battery tensioning spring 4. The latter is electrically connected, in turn, to a contact sleeve 7 inserted into the lower part of the battery housing 2.

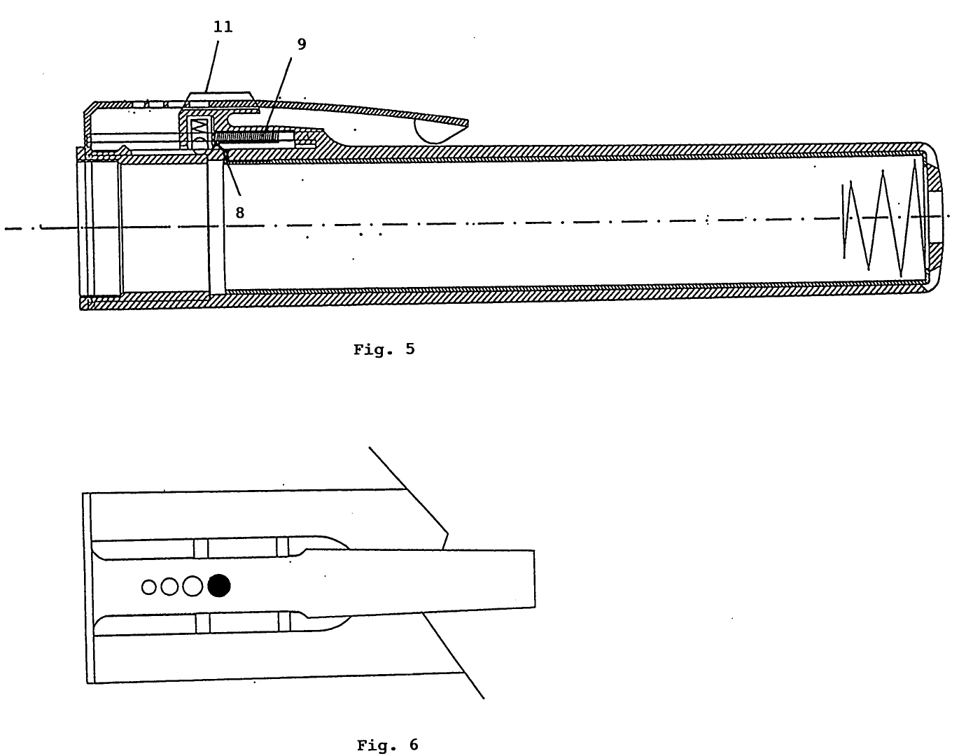

In the area of the clip 10, a sliding contact 8 of a sliding potentiometer is connected to the contact sleeve 7. In the illustration of FIG. 1, the sliding potentiometer is positioned in a current-interrupting position, i.e., the winding 9 of the sliding potentiometer has no contact with the sliding contact 8. In the illustrations of FIG. 3 and FIG. 5, the potentiometer is in a contacting position so that the incandescent light bulb 5 is electrically connected by means of the potentiometer with the negative terminal of the batteries. The electric circuit is thus closed so that the incandescent light bulb 5 emits light.

In order to move the sliding potentiometer from the current-interrupting position illustrated in FIG. 1 into the current-supplying position illustrated in FIG. 3, the operating element 11 arranged slidably on the main body 1 in the area of the fastening projection of the clip 10 is moved to the right. This can be realized, for example, by manipulation of the operating element 11 by the index finger of the hand holding the illumination device by acting on the upper side of the clip 10. However, a certain mechanical resistance must be overcome. The operating element 10 has a spring bushing 12 containing an elastic spring 13 and a ball 14. The ball 14 is pressed slightly by the elastic spring 13 against the receptacle 6 of the main body 1. When sliding the operating element 11, the ball 14 is guided in the longitudinal direction of the main body 1 across the receptacle 6. However, the receptacle 6 has a projection 15 along this travel path which presents an obstacle for the ball 14 when sliding of the operating element from the current-interrupting position into the current-supplying position. Upon moving the operating element 11, the ball 14 is therefore moved upwardly against the pressure of the elastic spring 13 into the spring bushing 12. Of course, the operator must exert an increased pushing force on the operating element which can be felt as a mechanical resistance. As soon as the ball 14 has reached the highest point of the projection 15, it glides downwardly on the opposite side as a result of the spring pressure. Now the operating element 11 is in the position illustrated in FIG. 3 in which the winding 9 of the sliding potentiometer contacts with its outer right end the sliding contact 8. In this way, the electric circuit is closed and the incandescent light bulb 5 is in operation. However, since the current must flow through the entire resistance of the winding 9, the brightness or luminance of the incandescent light bulb 5 is minimal. However, it can be continuously increased by moving the operating element and thus the winding 9 farther to the right. The effective resistance of the potentiometer is thus successively reduced so that the current flowing through the incandescent light bulb 5 and, accordingly, the luminance are continuously increased. The maximum luminance or brightness is achieved in the position of the operating element 11 shown in FIG. 5 in which the sliding contact is positioned on the left end of the winding 9 so that the additional resistance provided by the potentiometer within the circuit is reduced to zero.

For a visual representation of the adjusted brightness, as indicated in FIG. 2, the clip 10 is provided with four circular holes 16 arranged parallel to the longitudinal axis of the main body 1. They have a diameter increasing in the direction away from the incandescent light bulb 5. A small area of the operating element positioned directly underneath the holes 6 is provided with a color, for example, a red marking 17 (see FIG. 4). When the operating element 11 is now in the position illustrated in FIG. 1 in which current flow is interrupted, the marking is not visible, as shown in FIG. 2. All four holes 16 have the same color. In the current flow position with minimal illumination, i.e., in the current supply state of the device shown of FIG. 3, the movement of the operating element 11 required for reaching this position now makes visible the marking 17 under the first hole 16 with the smallest diameter. The color marking of the first hole 16 indicates to the user that the illumination device is in a current supply state in a position with minimal illumination. When the illumination is increased, the marking 17 appears sequentially in the holes 16 of increasing size. When the operating element 11 is in a position moved to the right to a stop, as illustrated in FIG. 5, the marking 17 is visible in the hole 16 with the greatest diameter, as illustrated in FIG. 6.

While specific embodiments of the invention have been shown and described in detail to illustrate the inventive principles, it will be understood that the invention may be embodied otherwise without departing from such principles.

What is claimed is:

1. A brightness-adjustable illumination device for manual use, comprising:
a main body;
an electric light source arranged in the main body;
a manually actuatable operating element arranged on the main body and configured to control brightness of the light source;
wherein the operating element is configured to be adjusted by a linear movement.

2. The illumination device according to claim 2, wherein the main body has a longitudinal axis and wherein the linear movement is realized parallel to the longitudinal axis of the main body.

3. The illumination device according to claim 2, wherein the main body is rod-shaped.

4. The illumination device according to claim 2, wherein the linear movement is a linear sliding movement.

5. The illumination device according to claim 1, configured to be continuously adjustable.

6. The illumination device according to claim 1, wherein the operating element comprises an adjustable electric resistor for controlling an electric current intensity flowing through the light source.

7. The illumination device according to claim 6, wherein the adjustable electric resistor is a sliding potentiometer.

8. The illumination device according to claim 7, wherein the sliding potentiometer has a sliding contact secured on the main body and wherein the sliding potentiometer has a winding movable relative to the sliding contact.

9. The illumination device according to claim 6, comprising a mechanical resistance element configured to provide a mechanical resistance when moving the operating element between a rest position without illumination output and an operating position with illumination output.

10. The illumination device according to claim 9, wherein the mechanical resistance element is a profile change on the main body and wherein the operating element comprises a spring element exerting a force when moving the operating element between the rest position and the operating position.

11. The illumination device according to claim 10, wherein the profile change is a projection.

12. The illumination device according to claim 9, further comprising an indicator device providing a visual representation of a brightness level of the illumination device.

13. The illumination device according to claim 12, wherein the indicator device represents the brightness level uniformly in steps.

14. The illumination device according to claim 12, further comprising a fastening device for detachable attachment of the illumination device on objects.

15. The illumination device according to claim 14, wherein the fastening device is a clip.

16. The illumination device according to claim 14, wherein at least one of the operating element, the adjustable electric resistor, the mechanical resistance element, the indicator device is arranged in the area of the fastening device.

17. The illumination device according to claim 14, wherein at least one of the operating element, the adjustable electric resistor, the mechanical resistance element, the indicator device is substantially integrated into the fastening device.

18. The illumination device according to claim 1, wherein the main body comprises a housing for receiving at least one battery for operating the electric light source.

19. The illumination device according to claim 1 in the form of an otoscope, an ophthalmoscope, or a manual slit lamp.
